(19) United States
(12) Patent Application Publication
(10) Pub. No.: US 2013/0253838 A1
(43) Pub. Date: Sep. 26, 2013

(54) SYSTEM AND METHOD FOR PROCESSING 4D SEISMIC DATA

(71) Applicants: Sandra Tegtmeier-Last, San Ramon, CA (US); Gilles Hennenfent, San Ramon, CA (US)

(72) Inventors: Sandra Tegtmeier-Last, San Ramon, CA (US); Gilles Hennenfent, San Ramon, CA (US)

(73) Assignee: Chevron U.S.A. Inc., San Ramon, CA (US)

(21) Appl. No.: 13/804,029

(22) Filed: Mar. 14, 2013

Related U.S. Application Data
(60) Provisional application No. 61/685,870, filed on Mar. 26, 2012.

(51) Int. Cl. G01V 1/36

(52) U.S. Cl. CPC G01V 1/364
USPC 702/17

(57) ABSTRACT

A system and method for determining a 4D difference from 4D seismic data including receiving a baseline seismic dataset and a monitor seismic dataset; identifying a 4D signal present in the monitor seismic dataset to create a 4D monitor dataset and a signal in the baseline seismic dataset which matches the monitor seismic dataset to create a baseline matching signal dataset; differencing the baseline matching signal dataset and the baseline seismic dataset to create a 4D baseline dataset; and differencing the 4D baseline dataset and the 4D monitor dataset to create a 4D difference dataset. In an embodiment, a multi-scale, multi-directional transform is used to identify the 4D signal present in the monitor seismic dataset and the signal in the baseline seismic dataset which matches the monitor seismic dataset.

### FIELD OF THE INVENTION

The present invention relates generally to methods and systems for processing seismic data and, in particular, methods and systems for processing 4D seismic data.

### BACKGROUND OF THE INVENTION

Development of hydrocarbon reservoirs may be efficiently done with the help of seismic data, which must be properly processed in order to allow interpretation of subsurface features including changes in fluid content. Generally, seismic data is acquired by using active seismic sources to inject seismic energy into the subsurface which is then refracted or reflected by subsurface features and recorded at seismic receivers. For 4D seismic data, a baseline seismic survey is performed to obtain a baseline seismic dataset and subsequent monitoring seismic surveys are performed to obtain one or more monitor seismic dataset(s). In practice, seismic data is often contaminated by noise which may be coherent or incoherent (e.g. random) in nature. In 4D seismic comparisons, slight differences in survey parameters and/or processing can result in differences in amplitude and/or phase which may further contaminate the results.

A standard method for calculating 4D quadrature differences between two seismic volumes acquired at different points in time is to subtract the volume of data acquired at an earlier time (the so called baseline) from the volume acquired at a later time (the so called monitor). After the subtraction, a −90 degree phase rotation is applied to the output volume yielding the so-called quadrature difference. Events in this quadrature difference volume are generally attributed to changes in the reservoir, assuming, of course, that the monitor and baseline data sets have undergone a similar, if not identical, processing sequence and were carefully matched to compensate for differences in acquisition geometry, mechanical source and receiver signatures etc. Since the conventional subtraction method is a straight sample-by-sample subtraction of the two data sets, minor differences, especially in the phase of the events, can cause large events in the output volume which can easily be mistaken for a 4D event.

Efficient and effective methods for attenuating noise and isolating signal in seismic data are needed to improve the final seismic image and allow differentiation of the 4D changes between the baseline and monitor seismic datasets.

### SUMMARY OF THE INVENTION

Described herein are implementations of various approaches for a computer-implemented method for processing 4D seismic data.

A computer-implemented method for processing 4D seismic data representative of a subsurface region of interest is disclosed. The method includes receiving a baseline seismic dataset and a monitor seismic dataset; identifying a 4D signal present in the monitor seismic dataset to create a 4D monitor dataset; identifying a signal in the baseline seismic dataset which matches the monitor seismic dataset to create a baseline matching signal dataset; differencing the baseline matching signal dataset and the baseline seismic dataset to create a 4D baseline dataset; and differencing the 4D baseline dataset and the 4D monitor dataset to create a 4D difference dataset.

In an embodiment, the method of identifying the 4D signal in the monitor dataset and the signal in the baseline seismic dataset that matches the monitor seismic dataset includes transforming the monitor seismic dataset using a multi-scale, multi-directional transform to create a set of monitor coefficients; transforming the baseline seismic dataset using a multi-scale, multi-directional transform to create a set of baseline coefficients; comparing the set of monitor coefficients to the set of baseline coefficients to determine if each monitor coefficient is within a range around each corresponding baseline coefficient and setting the monitor coefficient or the corresponding baseline coefficient to zero based on results of the comparison to create a compared set of monitor coefficients and a compared set of baseline coefficients; inverse transforming the compared set of monitor coefficients to create the 4D monitor dataset; and inverse transforming the compared set of baseline coefficients to create the baseline matching signal dataset.

In another embodiment, a computer system including a data source or storage device, at least one computer processor and a user interface to implement the method for processing 4D seismic data is disclosed.

In yet another embodiment, an article of manufacture including a computer readable medium having computer readable code on it, the computer readable code being configured to implement a method for processing 4D seismic data is disclosed.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims and accompanying drawings where:

FIG. 1 is a flowchart illustrating a method in accordance with an embodiment of the present invention;

FIG. 2 is a flowchart illustrating a step in an embodiment of the present invention;

FIG. 3 illustrates part of the step of FIG. 2;

FIG. 4 shows an application of an embodiment of the present invention;

FIG. 5 shows an application of one embodiment of the present invention;

FIG. 6 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, tablet devices, programmable consumer electronics, mini-computers, mainframe computers, and the like. The invention may also be practiced in distributed computing environments where tasks are performed by servers or other processing devices that are linked through one or more data communications networks. In a distributed computing environment, program modules may be located in both local and remote computer storage media including memory storage devices. The present invention may also be practiced as part of a down-hole sensor or measuring device or as part of a laboratory measuring device.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

The present invention relates to processing 4D seismic data to recover 4D signal components that are not common between two datasets by comparing the seismic volumes—monitor and baseline acquired at different points in time—in the transform domain of a multi-scale, multi-directional transform such as, but not limited to, the curvelet transform. The transform maps data into a higher-dimensional space allowing a comparison of localized wavefield components with different dip and frequency content as opposed to performing the conventional pixel-by-pixel comparison via straight subtraction. Therefore, a superior result can be expected for the recovery of the 4D wavefield differences between the two seismic volumes with fewer artifacts and less noise outside the reservoir zone where no 4D differences are present. The resulting volume can be used for interpretation or can serve as input for further processing such as the estimation of reservoir properties.

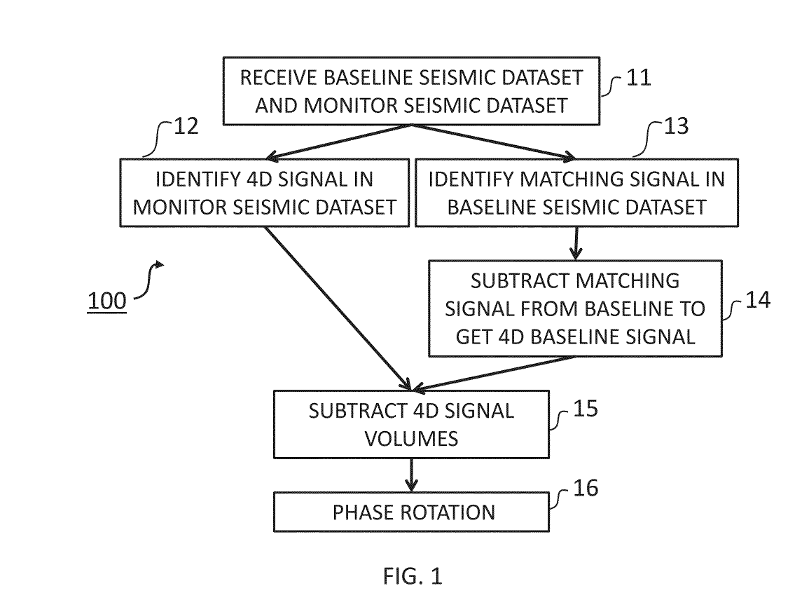

One embodiment of the present invention is shown as method 100 in FIG. 1. At operation 11, two seismic datasets are received. One of these datasets is the baseline seismic dataset. The other dataset is the monitor seismic dataset which was acquired at some time later than the baseline seismic survey. Typically, a monitor seismic survey is run after some process has occurred that is likely to alter the subsurface in some way, such as after hydrocarbons have been produced from a subsurface reservoir. There may be multiple monitor seismic datasets taken at different times after the baseline survey. Additionally, a dataset that was once considered a monitor seismic dataset may be considered a baseline seismic dataset in comparison to a later monitor seismic dataset. Moreover, the input datasets may be arranged and/or preprocessed in a variety of ways, including, by way of example and not limitation, stacks or partial stacks of seismic data, shot gathers, common receiver gathers, common offset gathers, offset vector tiles, common image gathers (angle or offset), and may be arranged in different directions such as inline, crossline, or depth/time slices; combinations of these may also be used. One skilled in the art will appreciate that other arrangements and preprocessing of the datasets are possible and can also be used as input for operation 11. Additionally, the seismic datasets may be recordings using active sources such as airguns or passive sources. The recordings may be made, for example, by towed streamers, ocean bottom cables, ocean bottom nodes, or land-based sensors such as geophones or accelerometers in any number of receiver array configurations including, for example, 2-D line surveys, 3-D surveys, wide-azimuth and full-azimuth surveys. Active sources may be fired simultaneously or sequentially, in linear source geometries or in alternative geometries such as coil shooting. Combinations of different source or receiver types may be used. Additionally, one or more of the seismic datasets may be synthetic data. One skilled in the art will appreciate that there are many ways to generate synthetic seismic data suitable for the baseline and/or monitor seismic datasets.

In an embodiment, there may be more than two input datasets. One input dataset would be the baseline seismic dataset. The other datasets would be multiple subsequent monitor seismic datasets. In this embodiment, the additional monitor seismic datasets would be treated in the same manner as the first monitor seismic dataset, as previously described, throughout the method.

Referring again to FIG. 1, once the baseline seismic dataset and monitor seismic dataset(s) are received 11 it is desirable to identify the 4D signal in the monitor seismic dataset 12. The 4D signal in the monitor seismic dataset is the energy which does not match the energy in the baseline seismic data; however, this 4D monitor signal is not necessarily solely representative of changes in the subsurface. Therefore, it is also desirable to identify the energy in the baseline seismic dataset that matches energy in the monitor seismic dataset 13 and then subtract that matching signal from the original baseline seismic survey to find the energy in the baseline seismic dataset, which may be called the 4D baseline signal, that does not match the monitor seismic survey 14. After the 4D monitor signal and the 4D baseline signal have been found, they are subtracted from each other at operation 15 to create a 4D difference dataset. The 4D difference dataset may then have its phase rotated, typically by −90 degrees, at operation 16 to create a 4D quadrature difference dataset.

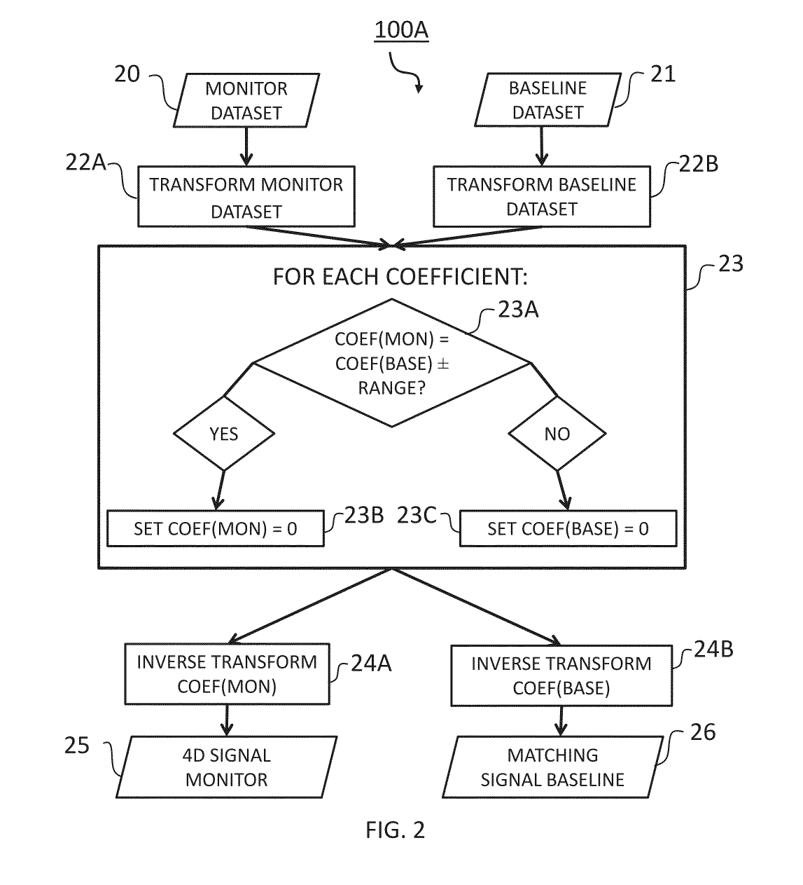

FIG. 2 illustrates a method 100A for performing operations 12 and 13 of method 100. The monitor dataset 20 and the baseline dataset 21 are transformed at operations 22A and 22B, respectively, into a domain in which they have a sparse or compressible representation. The transformation may be done using a multi-scale, multi-directional transform. The transformation may be performed on a 2-D section such as an inline or crossline section or a time or depth slice, or on a 3-D volume of data. The datasets may be transformed into the curvelet domain. These examples are not meant to be limiting; any domain in which the transformed data has a sparse or compressible representation may be used in this method. Additionally, one skilled in the art will appreciate that it is also possible to transform a 1-D trace into a domain in which the transformed data has a sparse or compressible representation.

At operation 23, the representative coefficients of the transformed monitor and baseline datasets are compared with each other. In some cases, an additional operation may be performed prior to the comparison to ensure that the comparison makes sense such as taking the absolute values of the sets of representative coefficients. For each coefficient, the operation 23A tests whether the monitor coefficient coef(mon) falls within a user-specified range or threshold as compared to the baseline coefficient coef(base). If the test is true, that monitor coefficient is set to zero 23B and the baseline coefficient is not changed. If the test is false, that baseline coefficient is set to zero 23C and the monitor coefficient is not changed. After all of the coefficients have been compared, the method continues on to operations 24A and 24B which inverse transform the tested monitor coefficients and the tested baseline coefficients, respectively. The result of the inverse transformed monitor coefficients is considered the 4D signal in the monitor seismic dataset 25 and the result of the inverse transformed baseline coefficients is considered the baseline seismic data which matches the monitor seismic data 26.

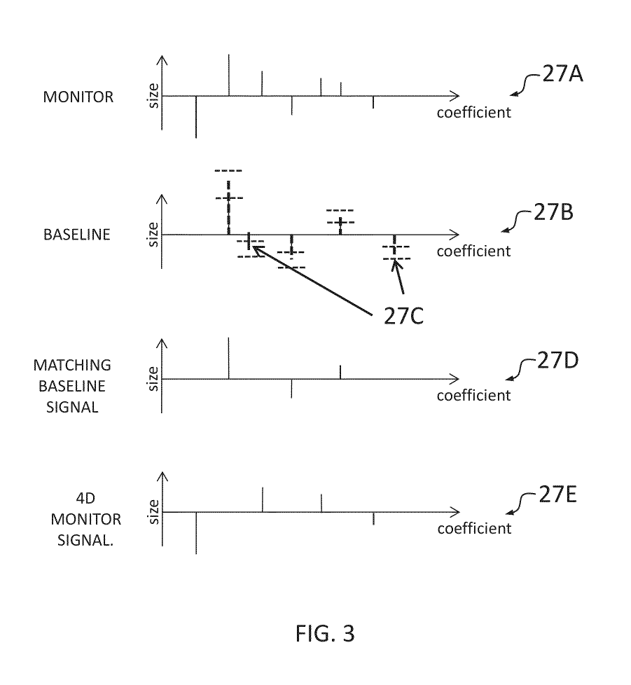

A process for performing operation 23A is shown in FIG. 3. Here, the monitor seismic dataset has been transformed into the curvelet domain and its coefficients are represented on graph 27A. The baseline seismic dataset has been transformed and is represented on graph 27B. Graph 27B shows the baseline coefficients in bold dashed lines overlain on corresponding monitor coefficients shown as thin solid lines. Graph 27B indicates a defined threshold for each baseline coefficient with the dashed horizontal lines. The defined threshold may be some default threshold (e.g. ±10%), be based on the distribution of coefficient sizes between the signal models, or be user-specified. Where the monitor coefficients fall within the ranges based on the baseline coefficients, the monitor coefficients are set to zero as shown in graph 27E; they match the baseline and thus are unlikely to represent changes in the subsurface. If the monitor coefficients do not fall within the ranges based on the baseline coefficients, the baseline coefficients are set to zero as shown in graph 27D where the coefficients labeled 27C have been zeroed out; those baseline coefficients do not match any of the signal in the monitor dataset and therefore may be noise in the baseline dataset.

It is also possible to modify the coefficients rather than passing them unchanged or zeroing them. In this embodiment, the coefficients are modified so as to allow differentiation between them but are not simply zeroed or passed. The modified coefficients may be, for example, averaged with coefficients from other monitor datasets. One skilled in the art will appreciate that there are many ways to modify the coefficients that will allow differentiation of the 4D signal in the monitor seismic dataset and baseline seismic data which matches the monitor seismic data.

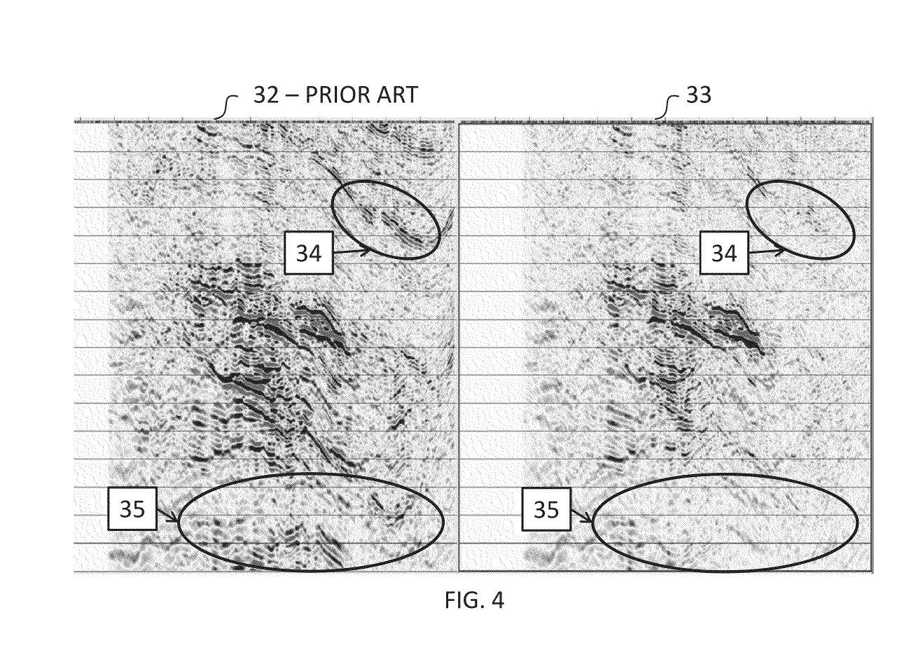

FIG. 4 illustrates the result of an embodiment of the method 100 of FIG. 1 as compared to the 4D quadrature difference of the prior art. Panel 32 shows the prior art result and panel 33 shows the 4D quadrature difference of the present invention. Ovals 34 and 35 indicate areas with substantially more energy in the prior art result. This energy is seen in areas that are suspected to have little change in subsurface properties so is likely to be due to differences in acquisition or processing between the baseline and monitor datasets. The result of method 100 shows substantially less energy in ovals 34 and 35, indicating that the differences in acquisition or processing have been successfully disregarded.

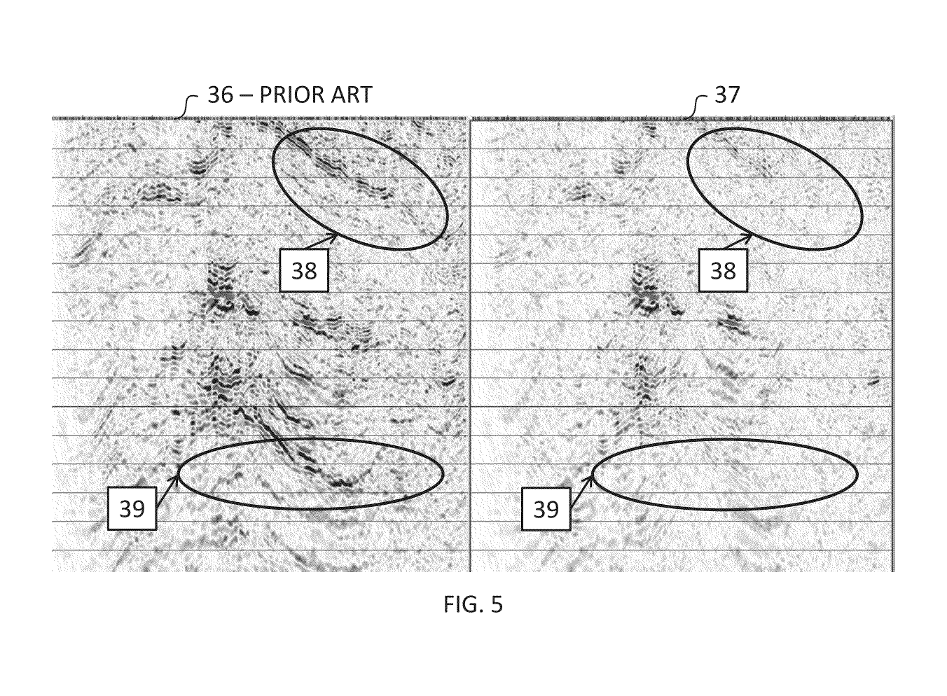

FIG. 5 illustrates another result of an embodiment of the method 100 of FIG. 1 as compared to the 4D quadrature difference of the prior art. Panel 36 shows the prior art result and panel 37 shows the 4D quadrature difference of the present invention. Ovals 38 and 39 indicate areas with substantially more energy in the prior art result while the result of method 100 shows substantially less energy, once again indicating that the differences in acquisition or processing have been successfully discarded.

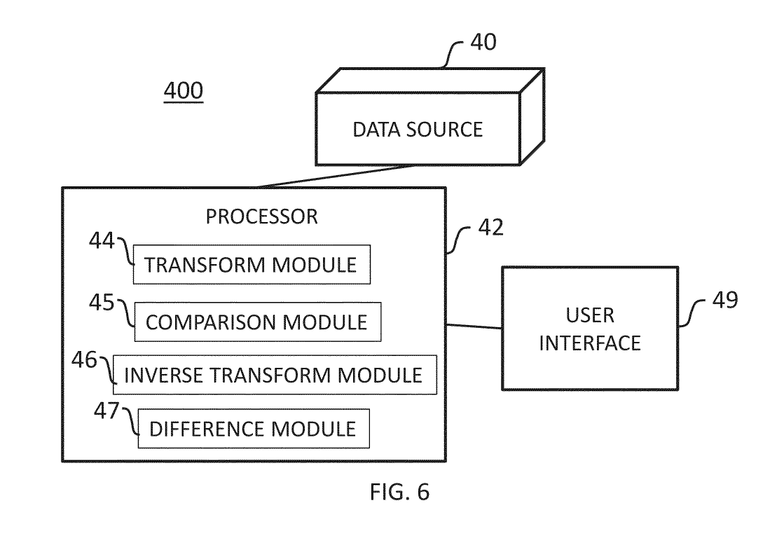

A system 400 for performing the method 100 of FIG. 1 using the refinement of method 100A of FIG. 2 is schematically illustrated in FIG. 6. The system includes a data source/storage device 40 which may include, among others, a data storage device or computer memory. The data source/storage device 40 may contain recorded seismic data or synthetic seismic data. The data from data source/storage device 40 may be made available to a processor 42, such as a programmable general purpose computer. The processor 42 is configured to execute computer modules that implement method 100. These computer modules may include a transform module 44 for implementing a multi-scale, multi-directional transform to transform the seismic data into a domain in which it has sparse representation, a comparison module 45 for comparing the coefficients of different transformed seismic datasets, an inverse transform module 46 for performing an inverse transform of the compared coefficients, and a subtraction module 47 for subtracting various original and processed seismic datasets from each other. The system may include interface components such as user interface 49. The user interface 49 may be used both to display data and processed data products and to allow the user to select among options for implementing aspects of the method. By way of example and not limitation, the 4D quadrature difference volume computed on the processor 42 may be displayed on the user interface 49, stored on the data storage device or memory 40, or both displayed and stored.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1) A computer-implemented method for determining a 4D difference caused by changes in a subsurface region of interest from 4D seismic data representative of the subsurface region of interest, the method comprising:
a. receiving, at a computer processor, a baseline seismic dataset and a monitor seismic dataset;
b. identifying, via the computer processor, a 4D signal present in the monitor seismic dataset to create a 4D monitor dataset;
c. identifying, via the computer processor, a signal in the baseline seismic dataset which matches the monitor seismic dataset to create a baseline matching signal dataset;
d. differencing, via the computer processor, the baseline matching signal dataset and the baseline seismic dataset to create a 4D baseline dataset; and
e. differencing, via the computer processor, the 4D baseline dataset and the 4D monitor dataset to create a 4D difference dataset.

2) The method of claim 1 further comprising phase rotating the 4D difference dataset to create a 4D quadrature difference dataset.

3) The method of claim 1 wherein the identifying the 4D signal present in the monitor seismic dataset and the identifying the signal in the baseline seismic dataset which matches the monitor seismic dataset comprises:
a. transforming the monitor seismic dataset using a multi-scale, multi-directional transform to create a set of monitor coefficients;
b. transforming the baseline seismic dataset using a multi-scale, multi-directional transform to create a set of baseline coefficients;
c. comparing the set of monitor coefficients to the set of baseline coefficients to determine if each monitor coefficient is within a range around each corresponding baseline coefficient and setting the monitor coefficient or the corresponding baseline coefficient to zero based on results of the comparison to create a compared set of monitor coefficients and a compared set of baseline coefficients;
d. inverse transforming the compared set of monitor coefficients to create the 4D monitor dataset; and
e. inverse transforming the compared set of baseline coefficients to create the baseline matching signal dataset.

4) The method of claim 3 wherein the multi-scale, multi-directional transform is a curvelet transform.

5) A system for determining a 4D difference caused by changes in a subsurface region of interest from 4D seismic data representative of the subsurface region of interest, the system comprising:
a. a data source containing seismic monitor and baseline data representative of the subsurface region of interest;
b. a computer processor configured to execute computer modules, the computer modules comprising:
i. an identification module for indentifying a 4D signal present in a monitor seismic dataset to create a 4D monitor dataset and a signal in a baseline seismic dataset which matches the monitor seismic dataset to create a baseline matching signal dataset; and
ii. a difference module for differencing the baseline matching signal dataset and the baseline seismic dataset to create a 4D baseline dataset and for differencing the 4D baseline dataset and the 4D monitor dataset; and
c. an user interface.

6) The system of claim 5 further comprising a phase rotation module.

7) The system of claim 5 wherein the identification module comprises:
a. a transformation module for transforming a monitor seismic dataset to create a set of monitor coefficients and a baseline seismic dataset to create a set of baseline coefficients wherein the transform is a multi-scale, multi-directional transform;
b. a comparison module for comparing the set of monitor coefficients and the set of baseline coefficients to determine which coefficients to set to zero to create a compared set of monitor coefficients and a compared set of baseline coefficients; and
c. an inverse transformation module to inverse transform the compared set of monitor coefficients and a compared set of baseline coefficients to create the 4D monitor dataset and the baseline matching signal dataset.

8) The system of claim 7 wherein the multi-scale, multi-directional transform is a curvelet transform.

9) An article of manufacture including a computer readable medium having computer readable code on it, the computer readable code being configured to implement a method determining a 4D difference caused by changes in a subsurface region of interest from 4D seismic data representative of the subsurface region of interest, the method comprising:
a. receiving, at a computer processor, a baseline seismic dataset and a monitor seismic dataset;
b. identifying, via the computer processor, a 4D signal present in the monitor seismic dataset to create a 4D monitor dataset;
c. identifying, via the computer processor, a signal in the baseline seismic dataset which matches the monitor seismic dataset to create a baseline matching signal dataset;
d. differencing, via the computer processor, the baseline matching signal dataset and the baseline seismic dataset to create a 4D baseline dataset; and
e. differencing, via the computer processor, the 4D baseline dataset and the 4D monitor dataset to create a 4D difference dataset.

10) The article of manufacture of claim 9 wherein the method further comprises phase rotating the 4D difference dataset to create a 4D quadrature difference dataset.

11) The article of manufacture of claim 9 wherein the identifying the 4D signal in the monitor dataset and the identifying the signal in the baseline seismic dataset which matches the monitor seismic dataset comprises:
a. transforming the monitor seismic dataset using a multi-scale, multi-directional transform to create a set of monitor coefficients;
b. transforming the baseline seismic dataset using a multi-scale, multi-directional transform to create a set of baseline coefficients;
c. comparing the set of monitor coefficients to the set of baseline coefficients to determine if each monitor coefficient is within a range around each corresponding baseline coefficient and setting the monitor coefficient or the corresponding baseline coefficient to zero based on results of the comparison to create a compared set of monitor coefficients and a compared set of baseline coefficients;
d. inverse transforming the compared set of monitor coefficients to create the 4D monitor dataset; and
e. inverse transforming the compared set of baseline coefficients to create the baseline matching signal dataset.

12) The method of claim 11 wherein the multi-scale, multi-directional transform is a curvelet transform.
